(19) United States
(12) Patent Application Publication
(10) Pub. No.: US 2004/0155598 A1
(43) Pub. Date: Aug. 12, 2004

(54) Mercury discharge lamps

(76) Inventors: Robin Devonshire, Fulwood (GB); Spyridon Kitsinelis, Sheffield (GB)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 10/471,146

(22) PCT Filed: Mar. 6, 2002
(86) PCT No.: PCT/GB02/01034

(30) Foreign Application Priority Data
Mar. 6, 2001 (GB) 0105491.5

(51) Int. Cl. H05B 37/02

(52) U.S. Cl. 315/246; 315/56; 315/60; 315/209 R

(57) ABSTRACT

A discharge units comprises a transparent envelope filled with a discharge gas containing mercury, and electrodes for exciting the gases by applying an electric field. It has been found that if, apart from the mercury vapour, the gas is about 99% argon and of the order of 0.1-1% krypton then the proportion of near-visible UV lines is increased, in relation to the 254-nm line, particularly if pulsed excitation is used. This increases the efficiency of the lamp when used to excite visible phosphors.

Standard white-light fluorescent lamps almost universally use a mercury discharge in a glass tube lined with a mixture of phosphors that when excited by radiation from the mercury discharge gives off a range of visible light wavelengths. Although this is a fairly efficient way of producing white light one drawback is that the bulk of the visible region phosphors are excited by the prominent mercury emission at 254 nm, which entails, therefore, a large energy loss on conversion to a visible phosphor emission.

A group of mercury emissions occurs near 365 nm in the near UV. It would be desirable for the discharge to emit radiation predominantly at this wavelength rather than at the 254 nm wavelength, because the energy loss involved in phosphor excitation and emission in the visible would be considerably less. The inventor's earlier application WO 99/04605 addresses this problem; in this disclosure the excitation of the gas is by means of very short (c. 1 μs) pulses at relatively long intervals (c. 100 μs). During the pulse therefore the discharge does not have time to establish its “quasi-steady state”, and many higher-energy mercury levels are present to a higher proportion than when the discharge is excited continuously. When the pulse is turned off these higher energy states decay, giving rise to the preponderance of 365 nm emissions during the afterglow. This technique can increase the proportion of the higher-wavelength plasma light emission by 100% or more. However, still further improvement is desirable.

According to the invention there is provided a discharge lamp comprising a transparent envelope filled with a discharge gas containing mercury, and a means for exciting the gases by applying an electric field, in which apart from the mercury vapour the gas is about 99% argon and of the order of 0.1-1% krypton.

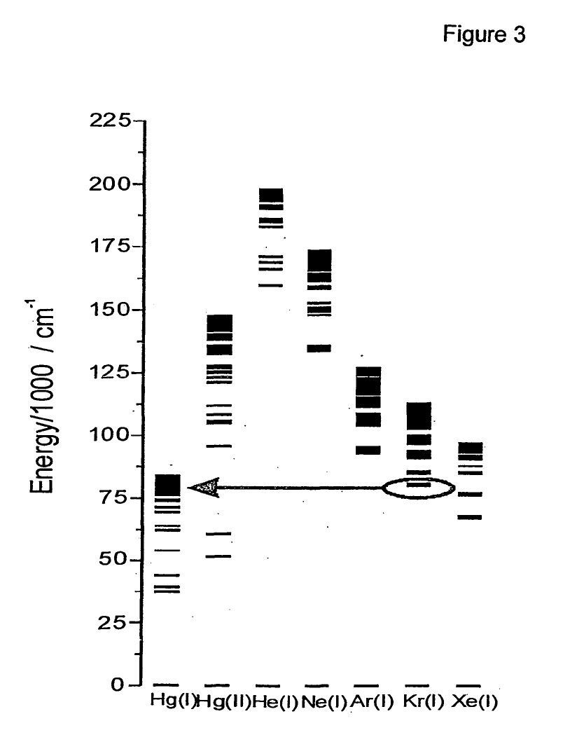

It has been discovered that the replacement of a small proportion of the usual argon “buffer” by krypton greatly increases the proportion of the higher-wavelength mercury lines in the afterglow. Krypton is heavier than argon and its excited-state energies are somewhat lower. It is thought that the effect may be due to the overlap on the one hand of the lower krypton levels with the upper mercury levels, and on the other hand of the upper krypton levels with the lower argon levels (see arrow in FIG. 3), thus providing a kind of bridge for the energy transfer to the higher mercury levels.

The most effective range of proportions of krypton to argon is about 0.2-0.8%; much lower, and the effect is negligible, higher, and the krypton damps the discharge and forms streamers. The pressure might be in the range 5-45 Torr, preferably about 25 Torr.

The gas mixture is effective only for pulsed discharges where the afterglow effect is present; pulse rates of 2-20 kHz and duty ratios of 1-10% are typical (i.e. pulse width=1-10% of pulse interval).

For a better understanding of the invention embodiments of it will now be described, by way of example, with reference to the accompanying drawings, in which:

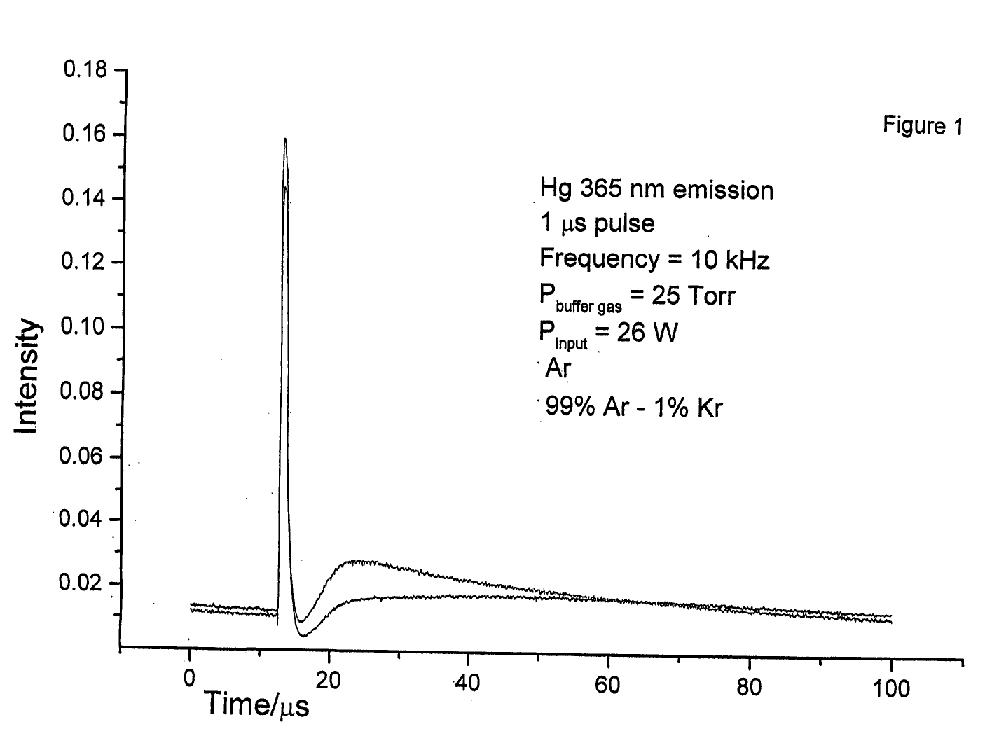

FIG. 1 shows a measurement of the afterglow effect as ascertained by the 365 nm line in a discharge according to an embodiment of the invention;

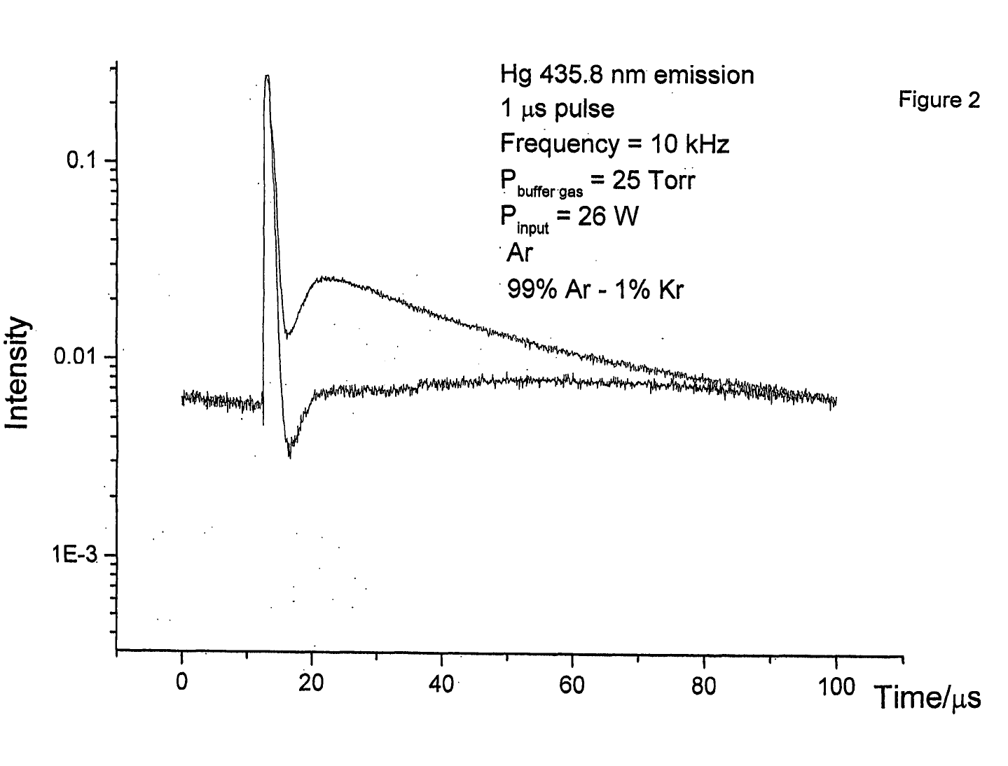

FIG. 2 shows similar-measurements for the 436 nm line;

FIG. 3 shows relative energy levels of the elements concerned; and

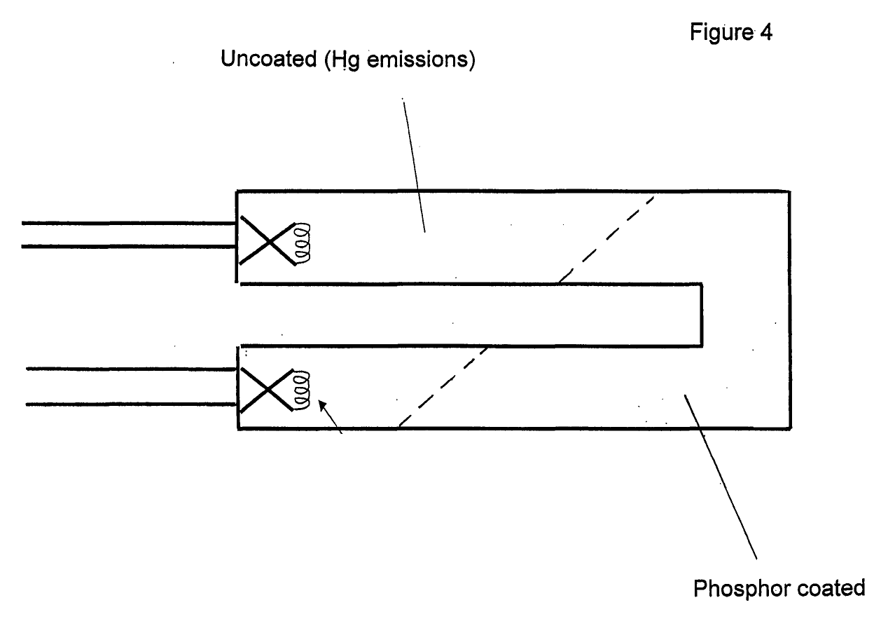

FIG. 4 shows schematically a discharge lamp for use with the invention.

1-μs pulses generated by a control unit at a voltage of about 500 V and a frequency of 10 kHz were applied to a discharge medium comprising 99% Ar and 1% Kr rare gas, with a reservoir of mercury. The resulting traces plotted in FIG. 1 show the initial rise in voltage as the pulse is applied, followed by the equally sudden drop as it decreases to zero, with the resulting afterglow. The upper trace represents the Ar—Kr results, while the lower is a comparative trial with 100%. Ar with mercury. As can be seen, over the most “productive” part of the afterglow the output of the pure-argon discharge is perhaps that of the mixture.

The result is even more striking in the FIG. 2 comparison where the 436 nm line is measured. Such visible lines are also valuable: they would not normally be used to excite phosphors, but they can be useful directly as visible light if the phosphors are carefully chosen to give a good balance of wavelengths. The effect of the invention generally is to improve all the emissions above 254 nm.

FIG. 3 shows the relative wavelengths of common excited states of the noble gases and mercury. It can be seen that there is a gap between the excited states of argon and those of mercury; it is thought that the krypton effectively bridges this gap and acts as an energy reservoir.

FIG. 4 shows an experimental discharge lamp having a glass envelope 1, anode 3 and cathode 5, and a partial phosphor lining 7. This phosphor lining is a mixture of phosphors chosen to emit over the visible range when excited by, in particular, the 365 nm radiation, and in a working lamp would obviously coat the entire inner wall of the envelope.

1. A discharge lamp comprising a transparent envelope filled with a discharge gas containing mercury, and a means for exciting the gases by applying an electric field, in which apart from the mercury vapour the gas is about 99% argon and of the order of 0.1-1% krypton.

2. A discharge lamp according to claim 1, in which the proportion of krypton is in the range 0.2-0.80.

3. A discharge lamp according to claim 1 or 2 and is further including a control unit adapted to apply a pulsed voltage to the discharge medium.

4. A discharge lamp according to claim 3, in which the duty ratio of the pulses is not more than 10%.

5. A discharge lamp according to any preceding claim, in which the lamp is lined with phosphor.

6. A method of operating a discharge lamp according to any preceding claim, in which pulses are applied at a frequency of about 2-20 kHz.
